(19) United States
(12) Patent Application Publication
(10) Pub. No.: US 2008/0101542 A1
(43) Pub. Date: May 1, 2008

(54) Collimator Methods and Apparatus

(76) Inventors: Abdelaziz Ikhlef, Versailles (FR); Joseph James Lacey, Cambridge, WI (US)

Correspondence Address: FISHER PATENT GROUP, LLC, 700 6TH STREET NW, HICKORY, NC, 28601, US

(21) Appl. No.: 11/551,200

(22) Filed: Oct. 19, 2006

(51) Int. Cl. G21K 1/02

(52) U.S. Cl. 378/147

(57) ABSTRACT

A method includes aligning a plurality of collimator plates to a plurality of cast reflector septa, and locking the collimator plates such that a gain change from changing rotational speeds is reduced or eliminated.

### BACKGROUND OF THE INVENTION

This invention relates generally to diagnostic imaging methods and apparatus, and more particularly, to methods and apparatus that provide for collimator stability during rotational velocity changes in a CT gantry.

The x-ray post-patient collimator used in CT detectors typically is a device made of a highly x-ray absorbing material such as Tungsten or Molybdenum which selects x-rays along a particular direction and rejects scattered radiation from other directions. In computed tomography (CT), collimators are placed in front of a detector bank to eliminate scattered radiation from the patient. The known collimators usually are made of Tungsten plates placed in front of interfaces of the detector cells, usually requiring a high precision manufacturing process and alignment or precision features within the individual parts for proper alignment. In the known designs, the collimator plates are aligned at pixel boundaries and have a plate in every channel or pixel. The dimensions of these plates are driven by the scatter/primary ratio and their ability to withstand higher g-forces without deflection.

In addition to the scatter rejection, the plates if misaligned to the cast septa (reflector) between the pixels, can cause spectral non-linearity and gain changes and introduce ring artifacts in imaging. In order to avoid or reduce these artifacts, the plates should be chosen so that they do not exhibit bow (flexing) in the beginning of a rotational change and should be locked with some mechanism so that they do not deflect more than a sufficiently small amount.

### BRIEF DESCRIPTION OF THE INVENTION

In one aspect, a method includes aligning a plurality of collimator plates to a plurality of cast reflector septa, and locking the collimator plates such that a gain change from changing rotational speeds is reduced or eliminated.

In another aspect, a method includes positioning a plurality of collimator plates each substantially in a pixel such that during rotational changes in velocity the collimator plates do not make contact or shadow with a reflector material surrounding each collimator plate.

In yet another aspect, a system includes an energy source, and an energy detector positioned to receive energy emitted from the source, wherein the energy detector includes a reflector and a plurality of collimator plates keyed to the reflector such the collimator plates do not move under rotational velocity changes of the energy detector.

In still another aspect, a system includes an energy source, and an energy detector positioned to receive energy emitted from the source, wherein the energy detector includes a reflector septa and a plurality of collimator plates mounted in the reflector septa, the collimator plates having a thickness of between about 250 μm and about 350 μm.

In still yet another aspect, a system includes an energy source, and an energy detector positioned to receive energy emitted from the source, wherein the energy detector includes a reflector and a plurality of collimator plates positioned on every other of a plurality of channels.

In yet still another aspect, a system includes an energy source, and an energy detector positioned to receive energy emitted from the source, wherein the energy detector includes a reflector septa and a plurality of collimator plates mounted in the reflector septa, the collimator plates having a thickness of between about 50 μm and about 150 μm.

### BRIEF DESCRIPTION OF THE DRAWINGS

FIG. 1 illustrates generally a plurality of plates that are aligned to cast reflector septa.

FIG. 2 illustrates that one way to avoid the gain change from one rotation speed to another rotation speed is to position the plates in the center of the pixels, so that, if the plates deflect, they do not reach the cast reflector boundaries, enabling no change in the gain.

FIG. 3 illustrates plates that are locked through grooves on the cast reflector aligned to septa.

FIG. 4 illustrates plates that are locked through grooves on the cast reflector aligned to center of the pixels.

FIG. 5 illustrates using thicker collimator plates and a known cast reflector septa. The plates in this design are placed every other channel. They are thicker and taller to enable better scatter-to-primary ratio.

FIG. 6 shows the calculation to get the same scatter/primary ratio at the same dose efficiency using 15.2 mm high collimators every other channel as with 7.6 mm high collimators every channel.

FIG. 7 illustrates that generally the plates are aligned to the cast reflector septa and a space is left between the plates and cast surfaces.

FIG. 8 illustrates thinner plates. In this case, even if the plates deflect, the gain change is not occurring because there will be no shadow change on the scintillator surface.

FIG. 9 illustrates the possibility to insert the plates in the reflector surface.

FIG. 10 illustrates an imaging system.

### DETAILED DESCRIPTION OF THE INVENTION

There are herein described methods and apparatus useful for imaging systems such as, for example, but not limited to an x-ray system. The apparatus and methods are illustrated with reference to the figures wherein similar numbers indicate the same elements in all figures. Such figures are intended to be illustrative rather than limiting and are included herewith to facilitate explanation of an exemplary embodiment of the apparatus and methods of the invention. Although, described in the setting of an x-ray system, it is contemplated that the benefits of the invention accrue to all diagnostic imaging systems and modalities such as PET, SPECT, fused systems such as a CT/PET system, and/or any modality yet to be developed in which collimator plates are used.

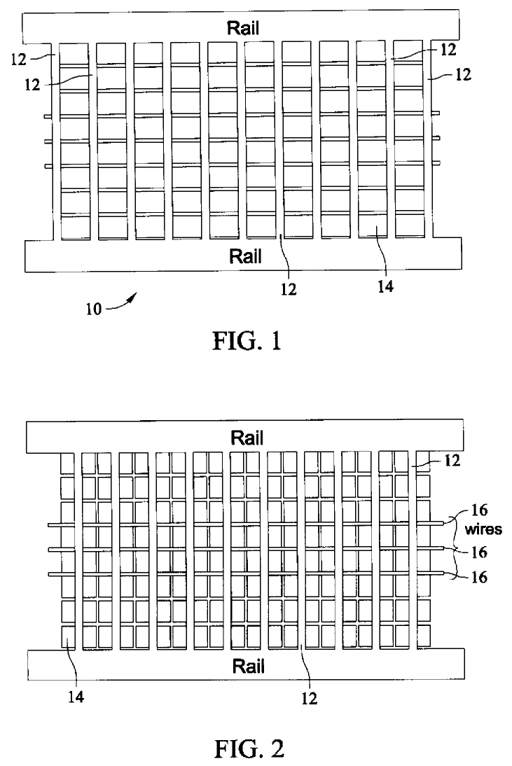

The herein described CT detector collimators 10 may be made of the same material as the known collimators, which can be, for example, Tungsten or Molybdenum. Generally, a plurality of plates 12 are aligned to the cast reflector septa 14 as shown in FIG. 1. Since the plates are aligned to the cast reflector between the pixels, any asymmetry in the deflection under gantry rotation, will introduce a gain change from calibration. This is due to the fact that the relative motion with respect to the cast reflector is random from channel to channel. In this case, if the plates are not locked accurately, a gain change from one rotation speed to another rotation speed will occur.

One way to avoid the gain change from one rotation speed to another rotation speed is to position the plates in the center of the pixels, so that, if the plates deflect, they do not reach the cast reflector, leading to no change in the gain. FIG. 2 illustrates this. For this purpose, one can use thin plates of Tungsten or Molybdenum of about 50% of the reflector dimension. In this case, the geometric efficiency will not be affected.

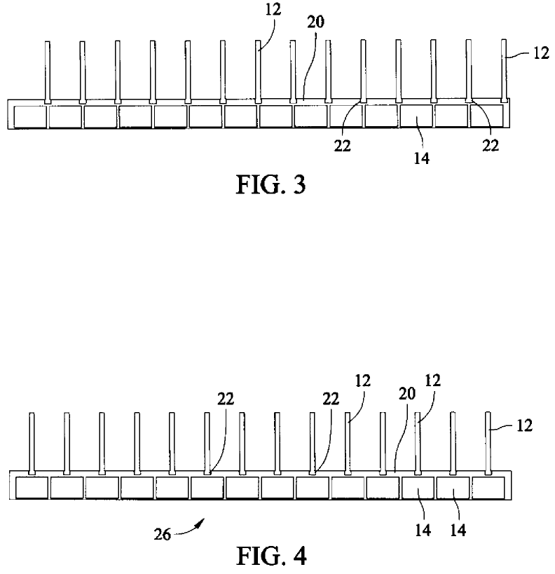

In essence, it becomes desirable and required to lock the plates through a mechanism which allows the plates to be fixed and stable under different rotation speeds. As explained earlier, one solution is to create grooves over the top reflector, deep and wide enough to insert the plates in. In this case, the plates become locked to the pack (scintillator array) and will not move relative to the pixels under rotational load. FIG. 3 shows a diagram for locking the plates in a detector, in accordance with one embodiment wherein the plates 12 are keyed to the septa 14 with grooves 22. Of course other keying methods may be used. FIG. 4 illustrates the keying with the plates 12 centered in the pixels. Also, of course, no physically real structure can withstand a large enough force without bending or flexing, therefore as used herein the changing rotational speeds or the fact that the herein described collimator plates do not move under rotational velocity changes refer to rotational velocity changes that are desirable for medical imaging and are foreseeable values as technology advances.

FIG. 3 illustrates plates 12 that are locked through grooves 22 on the cast reflector 20 aligned to septa 14, FIG. 4 illustrates plates 12 that are locked through grooves 22 on the cast reflector 20 aligned to center of the pixels 26.

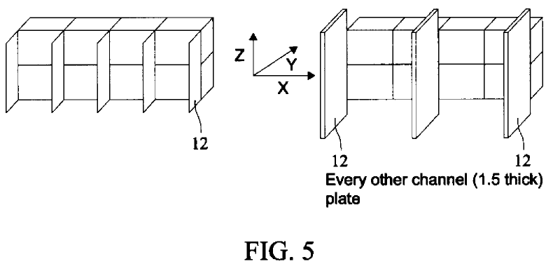

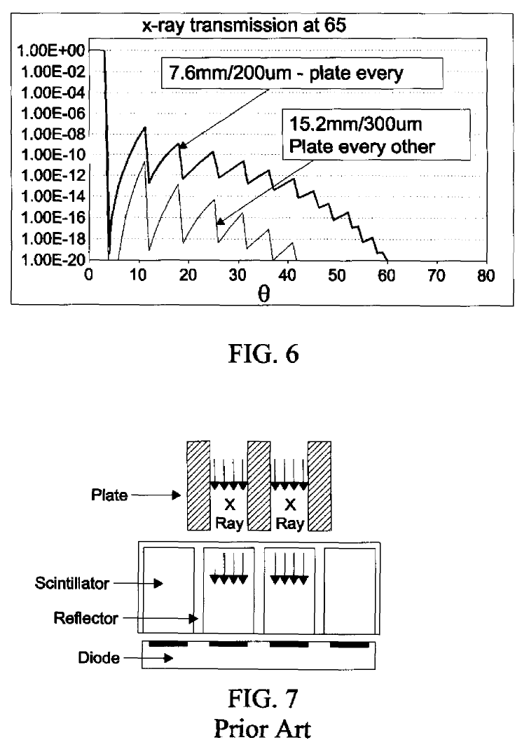

FIG. 5 illustrates using thicker collimator plates (e.g. about twice the current dimension) and the known cast reflector septa (e.g. 100 μm thickness). In this case, the alignment of the thick plate, will lead to a comfortable tolerance range, which is much better for manufacturability. In this configuration, the plates are positioned every other channel and made 2× taller. In addition to the alignment relaxation, there is no trade-off on geometric efficiency because the scintillator aperture did not change. FIG. 6 shows the calculation to get the same scatter/primary ratio at the same dose efficiency as the known 7.6 mm high and 200 μm thick plates every channel using the about 15.2 mm high and about 300 μm thick plates every other channel. This combination maintains the same scatter/primary ratio, while making the assembly stiffer with respect to the g-load due to rotation. Combined to Mo material usage, the deflection of the plates will be improved compared to the prior art collimators. The scatter radiation for angles beyond the primary solid angles is reduced because of the thickness of 300 μm instead of the known 200 μm. In some embodiments, instead of the thickness being about 300 μm, the thickness is from between about 250-350 μm, or from between about 270-320 μm.

The “every other channel” plate collimator, advantages include using 50% less plates (which reduces cost,) any flatness requirement maybe can be relaxed, any spectral edge effect maybe will be reduced, longer height (>15 mm) will enable >40 mm aperture with the same scatter, and that the scatter/primary ratio (high order) may be better than the prior art.

FIG. 7 illustrates that generally the plates are aligned to the cast reflector septa and a space is left between the plates and cast surfaces. As shown the plates are thicker than the cast reflector septa.

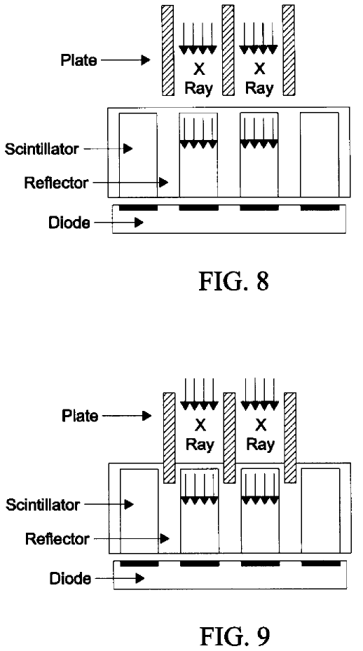

The herein described methods and apparatus address the desire to improve the overall detector performance versus high rotation speeds of gantry. One embodiment uses thinner collimator plates (50% of the reflector width) and wider cast reflector septa. In this case, the alignment of the thin plates, will lead to a better tolerance range for manufacturability, which is much better than the prior arts' capability. In addition to the alignment relaxation, there is no trade-off on geometric efficiency because the scintillator aperture would not change. There is an additional advantage in this configuration in the reduction of the crosstalk. Because of wider cast reflector septa, the amount of crosstalk (optical and x-ray) will be significantly reduced. FIG. 8 illustrates the thinner plates. The plates can be about 50% thick, from 50-150 μm thick, or from 80-120 μm thick.

Included in this disclosure, is the possibility to insert the plates in the reflector surface as shown in FIG. 9. In order to do this, grooves of about 100 μm length and a depth of about 10 to about 100 μm can be made on the reflector surface, in the septa. In other embodiments, the length can be from about 60-140 μm, or from about 80-120 μm. The depth can also be from about 20-80 μm or about 40-60 μm.

These grooves can be used also as guides for the plates. The insertion of these plates not only helps locking the plates and renders the alignment easier but avoids their deflection during rotation as well.

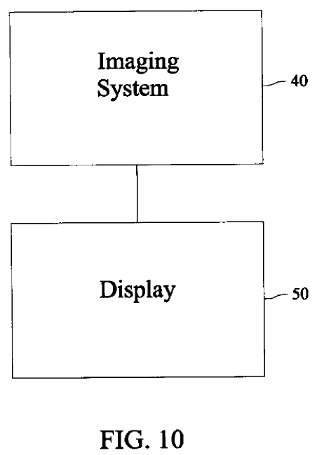

FIG. 10 illustrates an imaging system 40 with an associated display 50. Imaging system 40 can be of any modality, but in one embodiment, system 40 is a CT system. In another embodiment, system 40 is a dual modality imaging system such as a combined CT/PET. Display 50 can be separate from system 40 or integrated with system 40. System 40 includes an acquisition device such as an x-ray radiation detector. In all the above modalities, please note that there is energy traveling at least partially through at least one component of a body and impinging an energy detector. A computer is coupled to the detector for processing the received data and producing an image if desired. The energy detector may include collimators as described herein.

Of course, the methods described herein are not limited to practice in system 40 and can be utilized in connection with many other types and variations of imaging systems. Although the herein described methods are described in a human patient setting, it is contemplated that the benefits of the invention accrue to non-human imaging systems such as those systems typically employed in small animal research. Although the herein described methods are described in a medical setting, it is contemplated that the benefits of the invention accrue to non-medical imaging systems such as those systems typically employed in an industrial setting or a transportation setting, such as, for example, but not limited to, a baggage scanning CT system for an airport or other transportation center.

In some known CT imaging system configurations, a radiation source projects a fan-shaped beam which is collimated to lie within an X-Y plane of a Cartesian coordinate system and generally referred to as an “imaging plane”. The radiation beam passes through an object being imaged, such as a patient. The beam, after being attenuated by the object, impinges upon an array of radiation detectors. The intensity of the attenuated radiation beam received at the detector array is dependent upon the attenuation of a radiation beam by the object. Each detector element of the array produces a separate electrical signal that is a measurement of the beam attenuation at the detector location. The attenuation measurements from all the detectors are acquired separately to produce a transmission profile.

In third generation CT systems, the radiation source and the detector array are rotated with a gantry within the imaging plane and around the object to be imaged such that an angle at which the radiation beam intersects the object constantly changes. A group of radiation attenuation measurements, i.e., projection data, from the detector array at one gantry angle is referred to as a “view”. A “scan” of the object includes a set of views made at different gantry angles, or view angles, during one revolution of the radiation source and detector.

To reduce the total scan time, a “helical” scan may be performed. To perform a “helical” scan, the patient is moved while the data for the prescribed number of slices is acquired. Such a system generates a single helix from a cone beam helical scan. The helix mapped out by the cone beam yields projection data from which images in each prescribed slice may be reconstructed.

Either in a helical or non-helical scan, the gantry rotation velocity can be changed. The herein described methods and apparatus decrease or eliminate any gain change from the detector during these velocity changes.

As used herein, an element or step recited in the singular and proceeded with the word “a” or “an” should be understood as not excluding plural said elements or steps, unless such exclusion is explicitly recited. Furthermore, references to “one embodiment” of the present invention are not intended to be interpreted as excluding the existence of additional embodiments that also incorporate the recited features.

Technical effects include that the herein described methods and apparatus will allow for a high relaxation in plates bow and deflection tolerance of plates, no gain change from one speed to another, reduction in calibration time by only having a single speed calibration, Cost improvement by making the manufacturability easier, and Image Quality improvement by reducing the gain change from one speed to another. Use of thicker (x-direction) and taller (Z direction) plates in thin cast reflector septa will enable the improvement of detector performance and manufacturability process. This can be done through the relaxation of the alignment tolerance of both diode-to-scintillator alignment and the pack-to-collimator plates spacing. In addition to this, any deflection of plates under higher gantry rotations is significantly reduced, enabling one-speed calibration. In addition to performance, the cost of the collimator will be reduced by 50% of plates used, with less controllability and precision.

Exemplary embodiments are described above in detail. The assemblies and methods are not limited to the specific embodiments described herein, but rather, components of each assembly and/or method may be utilized independently and separately from other components described herein.

While the invention has been described in terms of various specific embodiments, those skilled in the art will recognize that the invention can be practiced with modification within the spirit and scope of the claims.

What is claimed is:

1. A method comprising:
aligning a plurality of collimator plates to a plurality of cast reflector septa; and
locking the collimator plates such that a gain change from changing rotational speeds is reduced or eliminated.

2. A method in accordance with claim 1 wherein each collimator plate is positioned substantially centered in a pixel such that during rotational changes in velocity the collimator plates do not make contact or shadow with the cast reflector septa surrounding each collimator plate.

3. A method in accordance with claim 1 wherein each collimator plate is positioned substantially centered in a reflector septa such that during rotational changes in velocity the collimator plates do not make contact or shadow with the cast reflector septa surrounding each collimator plate.

4. A method in accordance with claim 1 wherein each collimator plate is positioned substantially centered in a pixel and locked by grooves on the top reflector of the scintillating pixel such that during rotational changes in velocity the collimator plates do not make contact or shadow with the cast reflector septa surrounding each collimator plate.

5. A method in accordance with claim 1 wherein each collimator plate is positioned substantially centered in a reflector septa and locked by grooves in the reflector septa between pixels such that during rotational changes in velocity the collimator plates do not make contact or shadow with the cast reflector septa surrounding each collimator plate.

6. A method comprising positioning a plurality of collimator plates each substantially in a pixel such that during rotational changes in velocity the collimator plates do not make contact or shadow with a reflector material surrounding each collimator plate.

7. A method in accordance with claim 6 wherein the collimator plates and reflector material form a energy detector different than the traditional square array.

8. A method in accordance with claim 6 wherein the collimator plates and reflector material form a CT detector.

9. A method in accordance with claim 6 wherein the collimator plates are keyed to the reflector material.

10. A method in accordance with claim 9 wherein the reflector material comprises grooves to receive the collimator plates.

11. A method in accordance with claim 10 wherein the grooves are about 100 μm deep.

12. A method in accordance with claim 6 wherein the plates are tall enough to compensate accordingly for scatter rejection and these plates are positioned in every other channel.

13. A method in accordance with claim 11 wherein the plates are tall enough to compensate accordingly for scatter rejection.

14. A method in accordance with claim 13 wherein the collimator plates and reflector material form a CT detector different than the traditional square array.

15. A system comprising:
an energy source; and
an energy detector positioned to receive energy emitted from said source, said energy detector comprising a reflector and a plurality of collimator plates keyed to the reflector such the collimator plates do not move under rotational velocity changes of the energy detector.

16. A system in accordance with claim 15 wherein said reflector comprises grooves to receive said collimator plates.

17. A system in accordance with claim 16 wherein said grooves are about 100 μm deep.

18. A system comprising:
an energy source; and
an energy detector positioned to receive energy emitted from said source, said energy detector comprising a reflector septa and a plurality of collimator plates mounted in said reflector septa, said collimator plates having a thickness of between about 250 μm and about 350 μm.

19. A system in accordance with claim 18 wherein said reflector septa has a thickness of about 100 μm.

20. A system in accordance with claim 18 wherein said plates have a height of about 15 mm.

21. A system comprising:
an energy source; and
an energy detector positioned to receive energy emitted from said source, said energy detector comprising a reflector and a plurality of collimator plates positioned on every other of a plurality of channels.

22. A system comprising:
an energy source; and
an energy detector positioned to receive energy emitted from said source, said energy detector comprising a reflector septa and a plurality of collimator plates mounted in said reflector septa, said collimator plates having a thickness of between about 50 μm and about 150 μm.
